(19) United States
(12) Patent Application Publication
(10) Pub. No.: US 2015/0320082 A1
(43) Pub. Date: Nov. 12, 2015

(54) METHOD FOR PRODUCING FEED ADDITIVE RAW MATERIAL

(71) Applicant: KURITA WATER INDUSTRIES LTD., Nakano-ku, Tokyo (JP)

(72) Inventors: Hiromi AZUMA, Nakano-ku, Tokyo (JP); Tetsurou FUKASE, Nakano-ku, Tokyo (JP); Satoshi NAKAYAMA, Tokyo (JP)

(73) Assignee: KURITA WATER INDUSTRIES LTD., Nakano-ku, Tokyo (JP)

(21) Appl. No.: 14/650,783

(22) PCT Filed: Dec. 10, 2013
(86) PCT No.: PCT/JP2013/083051

§ 371 Date: Jun. 9, 2015

(30) Foreign Application Priority Data
Dec. 12, 2012 (JP) 2012-271515

(51) Int. Cl. A23K 1/00; A23K 1/10; A23K 1/18; C02F 11/02

(52) U.S. Cl. CPC A23K 1/007; C02F 11/02; A23K 1/10; A23K 1/188; C02F 2103/32

(57) ABSTRACT

Provided is a method for producing a feed additive raw material that can be used as a raw material of a feed additive for improving the palatability of feed and is capable of stably culturing animalcules containing a large amount of amino acids. A method for producing a feed additive raw material, comprising: a first biological treatment step of preparing a first biologically treated liquid containing dispersible bacteria by introducing an organic wastewater containing 40 wt % or more of protein to a first biological treatment tank and performing aerobic biological treatment with bacteria; a second biological treatment step of preparing a second biologically treated liquid by introducing the first biologically treated liquid to a second biological treatment tank and performing activated sludge treatment; and a sludge separation step of taking out part of the tank sludge from the second biological treatment tank as the feed additive raw material.

### FIELD OF INVENTION

The present invention relates to a method for efficiently producing feed additives for animal husbandry and fisheries using organic wastewater.

### BACKGROUND OF INVENTION

With the depletion of the world's natural resources, fish meal and other animal proteins used as raw materials of pisciculture feed have been reduced, and the cost thereof has been increased accordingly. Vegetable proteins, which have been increasingly used as alternatives, are inferior in digestibility and palatability, thus having some problems, such as low feed efficiency. An inexpensive animal protein has been desired accordingly.

Rotifer is widely used as animal feed for producing inocula or the like of marine fish. Patent Literature 1 (Japanese Patent Publication 57-65137 A) discloses a method for culturing rotifer in which sludge produced by biologically treating organic wastewater, such as food processing wastewater, is allowed to flow downward for culturing rotifer. Patent Literature 2 (Japanese Patent Publication 63-37611 A) discloses that rotifer is cultured and then separated for condensation with a plankton net.

Patent Literature 3 (Japanese Patent Publication 2010-187612 A) discloses a pisciculture feed containing amino acids and superior in growing fish.

Both of Patent Literatures 1 and 2, in which rotifer is cultured and concentrated, are intended to use the rotifer as pisciculture feed as it is, and do not have the viewpoint of improving palatability. In the feed of Patent Literature 3, a synthesized amino acid is used as the amino acid added to the feed, and accordingly manufacturing cost increases disadvantageously.

### LIST OF LITERATURE

Patent Literature 1: Japanese Patent Publication 57-65137 A

Patent Literature 2: Japanese Patent Publication 63-37611 A

Patent Literature 3: Japanese Patent Publication 2010-187612 A

### Object and Summary of Invention

It is an object of the present invention to provide a method for producing a feed additive raw material that can be used as a raw material of a feed additive for improving the palatability of feed and is produced by stably culturing animalcules containing a large amount of amino acids.

A method for producing a feed additive raw material of a first invention includes a first biological treatment step of preparing a first biologically treated liquid containing dispersible bacteria by introducing an organic wastewater containing 40 wt % or more of protein to a first biological treatment tank and performing aerobic biological treatment with bacteria; a second biological treatment step of preparing a second biologically treated liquid by introducing the first biologically treated liquid to a second biological treatment tank and performing activated sludge treatment; and a sludge separation step of taking out part of the tank sludge from the second biological treatment tank as the feed additive raw material.

A method for producing a feed additive raw material of a second invention includes a first biological treatment step of preparing a first biologically treated liquid containing dispersible bacteria by introducing an organic wastewater containing 40 wt % or more of protein to a first biological treatment tank and performing aerobic biological treatment with bacteria; a second biological treatment step of preparing a second biologically treated liquid by introducing the first biologically treated liquid to a second biological treatment tank and performing activated sludge treatment; a solid-liquid separation step of dividing the second biologically treated liquid into a separated sludge and a separated water by solid-liquid separation; and a sludge separation step of taking out part of the tank sludge and/or at least part of the separated sludge from the second biological treatment tank as the feed additive raw material.

In the second biological treatment step of the method for producing a feed additive raw material according to the first and second invention, it is preferable that the first biologically treated liquid is introduced to the second biological treatment tank and performed activated sludge treatment to obtain the second biologically treated liquid, and that animalcules prey on bacteria dispersed in the first treated water whereby animalcules are cultured.

In the method for producing a feed additive raw material according to the first and second invention, the sludge separation step is preferably performed by a first filtration step of performing filtration through a first filter with a mesh size of 500 to 2000 μm; and a second filtration step of performing filtration through a second filter with a mesh size of 20 to 50 μm after the first filtration step, thereby yielding the portion of the sludge that has passed through the first filter, but has not passed through the second filter as the feed additive raw material. The portion of the sludge that has not passed through the first filter and the filtrate that has passed the second filter are preferably returned to the second biological treatment tank.

In the method for producing a feed additive raw material according to the first and second invention, the first biological treatment tank in the first biological treatment step preferably has a BOD sludge load of 2 to 12 kg/kg-MLSS/d.

In the method for producing a feed additive raw material according to the first and second invention, the first biological treatment tank in the first biological treatment step preferably has a DO of 1 to 10 mg/L. The residence time in the first biological treatment tank is preferably 2 to 12 hours in the first biological treatment step.

In the method for producing a feed additive raw material according to the first and second invention, the organic wastewater preferably contains saccharide and/or crude fat.

### Advantageous Effects of Invention

The feed additive raw material produced by the present invention contains a plenty of amino acids and has an effect of improving palatability for fish or the like. More specifically, in the present invention, the organic wastewater introduced to a first biological treatment tank contains 40 wt % or more of protein. The present invention therefore can continuously and very efficiently produce solids containing rotifers and other animalcules containing a plenty of amino acids capable of improving palatability, and accordingly enables inexpensive feed production.

By culturing rotifers and other animalcules as a feed additive raw material using by-products, such as cooking liquid, discharged from food factories, the present invention not only contributes to resource conservation and the circulating society, but also provides a safe and inexpensive raw material.

### BRIEF DESCRIPTION OF DRAWINGS

FIG. 1 is a flow diagram of a process for culturing a feed additive according to an embodiment.

### DESCRIPTION OF EMBODIMENTS

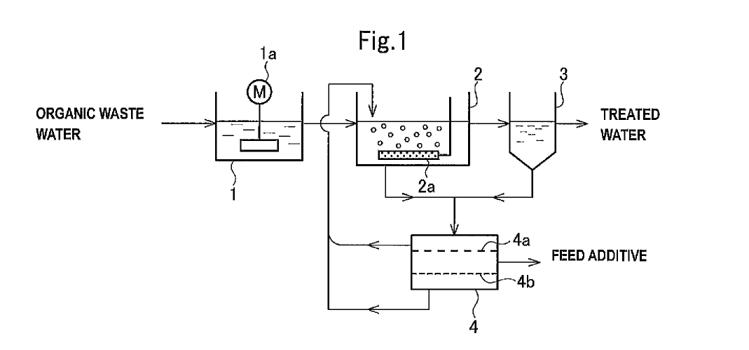

In the present invention, animalcules are cultured as shown in FIG. 1 by culturing bacteria by aerobically treating organic wastewater containing protein with a content of 40 wt % or more, such as 40 to 60 wt %, in a first aerobic reaction tank (biological treatment tank) 1, and introducing the first treated water in the first biological treatment tank 1 to a second aerobic reaction tank (biological treatment tank) 2 so that animalcules (protozoans, metazoans) can prey on bacteria dispersed in the first treated water. In FIG. 1, the second treated water in the second aerobic reaction tank 2 is introduced to a settling tank 3 and subjected to solid-liquid separation. The thus treated water is taken out of the system.

Part of the sludge in the second aerobic reaction tank 2 and the sludge settled in the settling tank 3 are introduced to a concentration tank 4. The concentration tank 4 is provided with a first filter 4a with a larger mesh size and a second filter 4b with a smaller mesh size. Sludge and metazoans having such sizes that they can pass through the first filter 4a but cannot pass through the second filter 4b are collected as a feed additive or a raw material thereof.

Examples of the organic wastewater containing 40 wt % or more of protein include food factory effluent (such as cooking liquid discharged from food factories), fish meal-dispersed water, animal husbandry wastewater, blood drainage, grain powder-dispersed water such as rice-washed water, crushed garbage-dispersed water, waste milk, and waste beverage. Preferably, the organic wastewater contains saccharide and/or crude fat with a total content of 10 wt % or more, such as 10 to 40 wt %, particularly preferably 20 to 40 wt %. This is because these constituents are essential for the growth of animalcules.

The organic wastewater is continuously passed through the first aerobic reaction tank 1 so that the residence time thereof is 2 to 12 hours, and thus the SOD component (organic component) is converted to bacteria (bacteria culture).

The first aerobic reaction tank 1 cultures bacteria intended for feed of rotifers and other animalcules. The bacteria intended for feed of rotifers and other animalcules are in the form of small flocks of about 3 to 20 μm, particularly 5 to 10 μm, and are preferably rich in protein and saccharide.

Such dispersible bacteria in the form of small flocks can be produced by continuous culturing under aerobic conditions using a substrate containing protein and saccharide, preferably using a water-soluble polymer compound as a substrate, with a residence time of about 2 to 12 hours. The DO concentration of the first aerobic reaction tank 1 is preferably 1 mg/L or more, particularly preferably 2 to 10 mg/L. Preferably, the first aerobic reaction tank 1 is provided with a stirrer 1a and is strongly stirred with the stirrer 1a.

The present invention is intended for stable large scale culture of animalcules, unlike the biological treatment of organic wastewater using animalcules (for example, Japanese Patent Publication 2006-247494 A). Therefore the BOD sludge load of the first aerobic reaction tank is set as very high as 2 kg/kg-MLSS/d or more, such as 2 to 12 kg/kg-MLSS/d, and the DO (dissolved oxygen) concentration is set as high as 1 mg/L or more, such as 1 to 10 mg/L, particularly 2 to 10 mg/L. At this time, furthermore, it is desirable that DO is equally supplied to the entirety of the reaction tank by strong stirring at a stirring intensity G value of 5 to 100 s⁻¹ to prevent dispersible bacteria from forming coarse flocks.

The pH of the first aerobic reaction tank 1 is preferably 5 to 9. If the substrate contains oil, the pH is preferably set slightly higher, specifically at about 8 to 9.

The residence time in the first aerobic reaction tank 1 is preferably 2 to 12 hours as mentioned above. If soluble starch, fish meat extract or the like is used as the organic wastewater, the residence time is preferably about 2 to 8 hours; if fish meal, gain powder or the like is used, it is preferably about 6 to 12 hours.

The first aerobic reaction tank 1 is preferably set to a temperature of 30 to 35° C., but may be set in the range of 10 to 40° C.

By culturing bacteria under these conditions, nutritious dispersed bacteria suitable for predation of animalcules is continuously produced in an amount of 40 to 70%, such as about 50%, relative to the weight of the organic matter in the introduced organic wastewater. Since the organic wastewater has a high protein content, the bacteria becomes rich in amino acids, and consequently the animalcules that have preyed on the bacteria also contain a large amount of amino acids.

The second aerobic reaction tank 2 continuously cultures animalcules. At the beginning of the culture, the first treated water is added from the first aerobic reaction tank 1, preferably together with a small amount of animalcules and optionally activated sludge or the like of the food factories or the like while the DO concentration is kept at 1 mg/L or more, such as 1 to 10 mg/L, particularly preferably 2 to 10 mg/L, by aeration with aeration means, such as a aeration tube 2a. This addition operation is preferably performed in a continuous manner, but may be in batches in the early stage. The second aerobic reaction tank 2 is preferably kept at a pH of 7 to 8. When the second aerobic reaction tank 2 is kept at a temperature of 25 to 30° C., a weight of bacteria equal to the weight of metazoans is preyed on per day. Preferably, this is given as a guide for the addition of the first treated water.

Continuation of this operation leads to a stable content of solids containing animalcules of about 3 to 10 g/L in terms of dry weight in the second aerobic reaction tank 2. The animalcules in the reaction tank include mainly rotifers that are metazoans, and small amounts of paramecium, artemia, daphnia and the like.

The second treated water in the second aerobic reaction tank 2 is introduced to a settling tank 3 and subjected to solid-liquid separation. The thus treated water is taken out of the system.

For collecting the metazoans, a first filter 4a is stretched across the concentration tank 4 at the upper position in the concentration tank 4, and a second filter 4b is stretched across the concentration tank at the lower position, and the settled sludge in the second aerobic reaction tank 2 and the settled sludge in the settling tank 3 are introduced to the upper side of the first filter 4a. The metazoans and sludge having such sizes that they can pass through the first filter 4a, but cannot pass through the second filter 4b are taken out from the concentration tank 4. Thus sludge containing metazoans is collected as a feed additive raw material.

The first filter 4a preferably has a mesh size of 500 to 2000 μm, particularly preferably 1000 to 1500 μm, and the second filter 4b preferably has a mesh size of 20 to 50 μm, particularly preferably 20 to 30 μm. Such filters allow metazoan-containing sludge having particle sizes of 20 to 2000 μm, particularly 50 to 500 μm, to be collected as a feed additive from the concentration tank 4.

Preferably, the sludge having large particle sizes that has not passed through the first filter 4a and the filtrate that has passed through the second filter 4b, which contains sludge having very small particle sizes, dispersed bacteria, protozoa, soluble organic component or the like, are returned to the second aerobic reaction tank 2.

In the present invention, only the sludge in the settling tank 3 may be introduced to the concentration tank 4.

When metazoans are collected, it is desirable that metazoans be partially left without collecting all the metazoans. Only an amount of metazoans equal to the amount increased on the previous day may be collected once a day. The amount (weight) of metazoans increased is 30% to 40% of the weight of bacteria fed. The first aerobic reaction tank 1 converts about 50% of the introduced saccharide and protein into bacteria as described above, and metazoans are produced in an amount of about 15 to 20 wt % relative to the saccharide and protein introduced to the first aerobic reaction tank 1.

The collected sludge containing metazoans may be used as a feed additive as it is. Alternatively, it may be dehydrated so as to be used as a feed additive, or may be dried so as to be used as a feed additive. Other additives may be added. Examples of such additives include vitamins, minerals, antibiotics, and food additives.

The feed additive produced using the present invention preferably contains 0.01 to 10 wt %, particularly preferably 1 to 10 wt %, of free amino acids in terms of dry weight. Metazoans containing such a large amount of free amino acids are superior in promoting feeding. Among free amino acids preferred are arginine, lysine, leucine, isoleucine, valine, alanine, glycine, proline, and glutamic acid. A free amino acid content in terms of dry weight represents a free amino acid content measured with an amino acid analyzer.

The feed additive produced by the method of the present invention is mixed with a feed, such as fish meal, to yield a mixed feed. The amount of the feed additive added to the mixed feed is preferably 0.5 to 20 wt %, particularly preferably 1 to 10 wt % in a state where the mixed feed has been dried at 105° C. to a constant weight.

The feed may be one or more of fish meal, cereal grains, soybeans, gluten meal, wheat flour, feed yeast, and fats and oils.

### EXAMPLES

### Example 1

Animalcules were cultured under the following conditions according to the flow shown in FIG. 1, and sludge containing metazoans was collected. The mesh size of the first filter 4a was 1000 μm, and the mesh size of the second filter 4b was 20 μm. The total amount of the sludge that had not passed through the first filter 4a and the filtrate that had passed through the second filter 4b was returned to the second aerobic reaction tank 2.

Raw water: fish processing wastewater containing 50 wt % of protein, 30 wt % of saccharide and 5 wt % of crude fat

First aerobic reaction tank
ROD sludge load: 5 kg/kg-MLSS/d
Stirring intensity G value: 5 s⁻¹
DO: 2 mg/L
pH: 7.0
Temperature: 27° C.

Second aerobic reaction tank
SRT: 25 days
DO: 2 mg/L
pH: 7.0
Temperature: 27° C.

The resulting metazoan-containing sludge was dehydrated and dried at 105° C. to a constant weight. A portion of the dried sludge was taken, and metazoans were extracted from the dried sludge. The metazoan content measured was 10 wt % relative to the dried sludge.

The dried sludge was subjected to amino acid analysis with an amino acid analyzer. The contents of major free amino acids were:

Free alanine: 0.95 wt %;

Free glycine: 0.39 wt %;

Free proline: 0.39 wt %; and

Free glutamic acid: 0.93 wt %,

(2.66 wt % in total). Thus, it was confirmed that the amino acid content was high.

The metazoan-containing sludge was dehydrated and dried to yield a feed additive with a water content of 6 wt %. A mixed feed was prepared by mixing 90 parts by weight of a commercially available pisciculture mixed feed (Nippon Suisan Kaisha, Ltd., Nissui Initial Feed D-2, total content of major amino acids: about 1.2 wt %) and 10 parts by weight of the feed additive.

Using this mixed feed, 20 sea bream fries (average weight: 33.0 g) were bred for 6 weeks. The average weight was measured and the result was 56.5 g.

### Comparative Example 1

Using only the above-mentioned pisciculture mixed feed, 20 sea bream fries were bred for 6 weeks in the same manner as in Example 1. The average weight was measured and the result was 50.7 g. These results suggest that the feed additive of Example 1 containing a large amount of amino acids have the effect of improving palatability.

### Comparative Example 2

Culture was performed in the same manner as in Example 1 except that the conditions of the raw water were varied as below:

Raw water: wastewater from a feed production process, containing 20 wt % of protein, 10 wt % of saccharide and 5 wt % of crude fat

The resulting metazoan-containing sludge was dehydrated and dried in the same manner as in Example 1. The content of the metazoans was measured and the result was 10 wt %. Also, amino acid analysis resulted in the following contents of major amino acids:

Free alanine: 0.0.1 wt %;

Free glycine: 0.04 wt %;

Free proline: not detected; and

Free glutamic acid: 0.07 wt %,

(0.12 wt % in total). Thus, the amino acid content was lower than that in Example 1, and was, in addition, lower than that in the commercially available feed used in Comparative Example 1.

A mixed feed was prepared in the same manner as in Example 1, except that the metazoan-containing sludge was dehydrated and dried to yield a feed additive with a water content of 6 wt %, and then, 20 sea bream fries were bred for 6 weeks in the same manner. The average weight of the fries was measured and the result was 44.5 g.

While the present invention has been described with reference to specific embodiments, it is to be understood by those skilled in the art that various modifications may be made without departing from the intention and scope of the invention.

The present application is based on Japanese Patent application No. 2012-271515 filed on Dec. 12, 2012, the entirety of which is incorporated herein by reference.

### REFERENCE SIGNS LIST

1 first aerobic reaction tank
2 second aerobic reaction tank
3 settling tank
4 concentration tank
4a first filter
4b second filter

1. A method for producing a feed additive raw material, comprising:
a first biological treatment step of preparing a first biologically treated liquid containing dispersible bacteria by introducing an organic wastewater containing 40 wt % or more of protein to a first biological treatment tank and performing aerobic biological treatment with bacteria;
a second biological treatment step of preparing a second biologically treated liquid by introducing the first biologically treated liquid to a second biological treatment tank and performing activated sludge treatment; and
a sludge separation step of taking out part of the tank sludge from the second biological treatment tank as the feed additive raw material.

2. A method for producing a feed additive raw material, the method comprising:
a first biological treatment step of preparing a first biologically treated liquid containing dispersible bacteria by introducing an organic wastewater containing 40 wt % or more of protein to a first biological treatment tank and performing aerobic biological treatment with bacteria;
a second biological treatment step of preparing a second biologically treated liquid by introducing the first biologically treated liquid to a second biological treatment tank and performing activated sludge treatment;
a solid-liquid separation step of dividing the second biologically treated liquid into a separated sludge and a separated water by solid-liquid separation; and
a sludge separation step of taking out part of the tank sludge and/or at least part of the separated sludge from the second biological treatment tank as the feed additive raw material.

3. The method for producing a feed additive raw material according to claim 1, wherein the sludge separation step is performed by:
a first filtration step of performing filtration through a first filter with a mesh size of 500 to 2000 μm; and
a second filtration step of performing filtration through a second filter with a mesh size of 20 to 50 μm after the first filtration step,
thereby yielding the portion of the sludge that has passed through the first filter, but has not passed through the second filter as the feed additive raw material.

4. The method for producing a feed additive raw material according to claim 3, wherein the portion of the sludge that has not passed through the first filter and the filtrate that has passed the second filter are returned to the second biological treatment tank.

5. The method for producing a feed additive raw material according to claim 1, wherein the first biological treatment tank in the first biological treatment step has a BOD sludge load of 2 to 12 kg/kg-MLSS/d.

6. The method for producing a feed additive raw material according to claim 1, wherein the first biological treatment tank in the first biological treatment step has a DO of 1 to 10 mg/L.

7. The method for producing a feed additive raw material according to claim 1, wherein the residence time in the first biological treatment tank is 2 to 12 hours in the first biological treatment step.

8. The method for producing a feed additive raw material according to claim 1, wherein the organic wastewater contains 10 to 40 wt % of saccharide and/or crude fat.

9. The method for producing a feed additive raw material according to claim 1, wherein the organic wastewater is food factory effluent, fish meal-dispersed water, animal husbandry wastewater, blood drainage, grain powder-dispersed water, crushed garbage-dispersed water, waste milk, or waste beverage.

10. The method for producing a feed additive raw material according to claim 1, wherein the organic wastewater is food factory effluent.

11. The method for producing a food additive raw material according to claim 1, wherein the first biological treatment tank is stirred at a stifling intensity G value of 5 to 100 s⁻¹.

12. The method for producing a feed additive raw material according to claim 1, wherein the solid in the second biological treatment tank contain animalcules mainly including rotifers.

13. The method for producing a feed additive raw material according to claim 1, wherein the resulting feed additive contains 0.01 to 10 wt % of free amino acids in a dried state.
